(19) United States
(12) Patent Application Publication
(10) Pub. No.: US 2017/0116285 A1
(43) Pub. Date: Apr. 27, 2017

(54) Semantic Location Layer For User-Related Activity

(71) Applicant: Microsoft Technology Licensing, LLC, Redmond, WA (US)

(72) Inventors: Dikla Dotan-Cohen, Herzliya (IL); Ido Priness, Herzliya (IL); Ido Cohn, Tel Aviv (IL); Haim Somech, Ramat Gan (IL); Gal Lavee, Tel Aviv (IL)

(21) Appl. No.: 14/923,573

(22) Filed: Oct. 27, 2015

(51) Int. Cl. G06F 17/30

(52) U.S. Cl. CPC G06F 17/30528; G06F 17/30483

(57) ABSTRACT

Event information is provided to a user in response to receiving a request to retrieve event information associated with the event. At least one event occurring at a particular time on a computing device associated with a user is detected and stored as an event record. The event record can include event characteristics, as well as references to files and/or data associated therewith. A request is received, preferably through a personal assistant-type application, to retrieve information associated with the event. The request may include one or more search parameters corresponding to the event characteristics. Based on the request, the event can be located and communicated to the user.

### BACKGROUND

People oftentimes visit familiar locations out of personal preference or necessity. For instance, a person may have a preference for a particular coffee shop that they visit several times a week. Similarly, out of necessity, a person may arrive at a particular office building every morning for work. Most locations, like the coffee shop or the office building, can have different significance to different people. For one person, the coffee shop might simply be their “favorite coffee shop”—their preferred venue for purchasing caffeinated beverages. For another person, however, the coffee shop might be their “work”—their place of employment. In this regard, different people may have different semantic identifiers for any one particular location.

Sometimes, when a person is at a familiar location, the person may actively or passively engage in some sort of electronic event on their computing device. For instance, while at the location, the person may send an email, receive a text, visit a website, take a picture, spend time with a friend, and the like. Later, the person might forget details associated with the event. However, the person may recall general details surrounding the event, such as the semantic location identifier (e.g., “work”) at which the event took place, a temporal descriptor (e.g., “yesterday”) associated with the event, and the event type (e.g., email, text, webpage, picture, etc.). The person may desire to recall specific details associated with the event providing only these general details.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments described in the present disclosure are directed towards recalling information related to computing device events associated with a user. In particular, embodiments may retrieve event information associated with a prior event that occurred in connection to a user's computing device when provided with a proper event query. The event query may include a keyword that references a type or classification of the prior event, a semantic identifier associated with where the event took place, and/or a temporal descriptor associated with the prior event. In embodiments, the computing device is associated with a user (i.e., via a user account) so that sensor data, event records, user location history, user-specific semantic identifiers, and other data, can be collected therefrom and also associated with the user.

In embodiments described herein, a user-data collection component can be employed to detect, among other things, events that occur on the computing device(s) and subsequently record details associated with the detected events in an event history register associated with the user. The event history register can store or log a plurality of event records. Each event record can include information about the event (e.g., associated files, associated titles or words, user friends associated with the event, etc.), the type of event (e.g., email, text, webpage visit, picture taken, etc.), physical location data (e.g., location coordinates) associated with the event, and an event timestamp corresponding to a time the event happened or was detected, as will be described in more detail herein.

In some embodiments, computing device(s) associated with a user can further employ the user-data collection component to utilize sensors to generate location data relevant to a user's physical location or logical location at any given time. For instance, location data can be generated, by way of example only, on an ongoing basis, at predetermined intervals, upon the occurrence of an event, upon a sensed movement, or any other variable temporal interval. A location value history register can be employed to record the actual physical location of the user at any particular time. Each location data point in the location value history register can include a location value (e.g., a location coordinate) and a timestamp corresponding to the time the location value was generated and/or received. To this end, if recollection of a prior location of a user at a particular time is desired, the location value history register can analyze the location data to determine a precise physical location of the user at the particular time. The terms “location value” or “physical location” are used broadly herein to include any description for a location that can be interpreted by a user or computer application to determine a particular geographic locus. By way of example and not limitation, a location value can include GPS coordinates, latitude and longitude coordinates, an address, Earth Centered Earth Fixed (ECEF) Cartesian coordinates, Universal Transverse Mercator (UTM) coordinates, Military Grid Reference Systems (MGRS) coordinates, and the like.

In some embodiments, a user hub inference engine can be provided to analyze the location data recorded in the location value history register. When provided with location data, the user hub inference engine can generate one or more inferences that certain locations visited by a user are significant to the user. In some aspects, a clustering algorithm may be employed to analyze the location data by algorithmically mapping the location values to generate clusters inferring possible significant locations. In more detail, the user hub inference engine may determine, based on location data in the location value history register, that clusters of location values mapped by the clustering algorithm may infer a potentially significant location for the user. The user hub inference engine may further consider the number of unique location values within each cluster, along with patterns detected therein, in addition to other sensor data associated with the user, to compute a confidence score corresponding to each potentially significant location. To this end, a potentially significant location with a high confidence score may be determined as a user-significant location (herein also referred to as a “user hub”). Each user hub can correspond to a physical or logical location or “location value.” In some instances, each user hub can correspond to a plurality of location values, for instance, a small cluster of location values immediately surrounding a physical or logical location. For example, in regards to logical locations, a user who works in different physical locations, such as a traveling business person, may be considered to be logically located at a “work” user hub when the user is working.

In some embodiments, a semantic labeling component associated with the user can be provided to associate a location label with each user-significant location or “user hub.” The location label is, in essence, a semantic identifier, which can be any one or more terms having semantic significance to the user for use in conjunction with any particular user hub. For instance, and by way of example only, “favorite coffee shop” or “work” can both be classified as location labels corresponding to distinct user hubs, with each user hub also corresponding to at least one particular location value. The semantic labeling component can be associated with a user, such that any user can have a personal set of location labels that correspond to their user hubs. As will be described, the semantic labeling component can associate location labels to user hubs based on suggestions made to and confirmed by the user, or alternatively, based on direct inputs provided by the user.

In accordance with embodiments described herein, a semantic recollection component can be provided to employ the location value history register, the semantic labeling component, and the event history register, to retrieve a particular event record from the event history register based on a received event query. In other words, a user may desire to recall details related to a computing device event that occurred at a particular user hub around a particular timeframe. Embodiments of the present disclosure can receive an event query including, among other things, the type of event, a reference to a location label, and a general timeframe, to retrieve information associated with a past event that meets the parameters defined by the event query.

### BRIEF DESCRIPTION OF THE DRAWINGS

Aspects of the present disclosure are described in detail below with reference to the attached drawing figures, wherein:

FIG. 1 is a block diagram of an example operating environment suitable for implementing aspects of the present disclosure;

FIG. 2 is a diagram depicting an example computing architecture suitable for implementing aspects of the present disclosure;

FIG. 3 depicts one example of a cluster diagram used in a user hub determination analysis, in accordance with an embodiment of the present disclosure;

FIG. 4 depicts one example of search result content that may be presented to a user, in accordance with an embodiment of the invention;

FIGS. 5-6 depict flow diagrams of methods for recalling information related to past computing device events, in accordance with an embodiment of the present disclosure; and

FIG. 7 is a block diagram of an exemplary computing environment suitable for use in implementing an embodiment of the present disclosure.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Modern computing devices can sense and collect a wide variety of raw data about a user. This raw user-specific data may include the user's actions, whereabouts, interests, habits, preferences, relationships, vernacular, and the like. In order to improve the user experience, particularly across one or more computing devices associated with the user, user-specific raw data is typically stored on a cloud-based server to, ideally, be accessed and utilized by all computing devices associated with the user. For instance, cloud-based personalization-related (e.g., “personal assistant”) applications can be configured to interpret user-specific raw data to facilitate a personalized experience. However, in order to create a more “human-like” interaction and to relate to the user in a more personalized manner, personalization-related applications can be configured to associate user-specific vernacular to relevant portions of the raw data. As described herein, semantic identifiers can be collected and associated to raw data, such that the user can reference the raw data in a vernacular that is easy for the user to comprehend.

Semantic identifiers familiar to a user can generally be associated with relevant portions of the user's raw data. For instance, a user might assign a location label of “favorite coffee shop” with a particular location value (e.g. GPS coordinates). While semantic identifiers can generally be associated with relevant portions of raw data, there is a need for the ability to harness semantic identification of raw data when conducting simple, or even complex, queries.

In this regard, as users are becoming increasingly reliant on computing devices for completing everyday tasks, it is oftentimes desirable to recall events that may have been sensed by or performed on the computing devices. While computing devices may be operable to sense and store information about computing device events that occur thereon, such information is typically in the form of raw data and uninterpretable by the average user. Further, even if this raw data is available to the user for viewing or querying, conducting queries to sort out and find a particular record can be rather complex.

As such, aspects of the technology described herein are directed towards recalling information related to computing device events associated with a user. More particularly, embodiments may recall past computing device event information by interpreting an event query in natural language form, and conducting a search on user data based on the event query parameters.

Aspects of processing event queries using natural language rely heavily on user semantic identifiers in association with raw data (i.e., location data) associated with the users. Embodiments can receive sensor data associated with a user and, from this, collect or “track” physical location information associated with the user. To this end, semantic identifiers for locations significant to a user, otherwise known herein as “location labels” for “user hubs,” can be associated with a user and stored in, for instance, a user profile for quick referencing.

In some embodiments, identification of user hubs can require the employment of an inference engine configured to infer one or more locations significant to the user based at least in part on the user's location history, as will be described in more detail herein. In some aspects, the user can be prompted upon an inference being made that a particular location value is a user hub, the prompting to confirm whether a particular physical location is significant to the user and thereby defining the user hub. In this regard, if a user confirms that a particular location is significant, the user may be prompted to associate a location label with the physical location. For instance, if a user's location history indicates that a user is present at a location value (e.g. “47.642, −122.136”), for five days a week, and for at least eight hours a day, an inference can likely be made that this location value is significant to the user. As such, the user may be prompted to associate a location label (e.g., “work”) with the location value. In some other aspects, the user can proactively input and associate a location label with a particular location (i.e., via a location point on a map, a presently-detected location, or in association with an inferred user hub).

Computing devices may also be configured to process a wide variety of events. Such events may include a wide variety of associated information as well. For instance, a device event may include an incoming/outgoing phone call, a sent/received text message or email, a voicemail received, a picture taken/shared/viewed, a detection of a location, a webpage visited, and the like. Such events may include associated information, such as, respectively, a name of the individual that the incoming/outgoing phone call was with, message content of the sent/received text message or email, content of the voicemail received, image data from the picture(s) taken/shared/viewed, name of the detected location, name of an associated friend that was also at the detected location, a URL of the webpage visited, and more. Similar to the collection of a user's location history, a user's device event history may be collected and associated with the user. While it may be inefficient to store all detail related to an event, significant information such as the type of event, a timestamp corresponding to a time the event occurred, and other information associated with the event may be logged. Other information may include, as was briefly described, contact information, message content, names of people, names of places, URLs, or references (i.e., pointers or storage locations) to data associated with the event (e.g., contact information, images, audio, video, attachments, other media, etc.).

In embodiments described herein, user data can include, among other things, device event history, device location history, and user-defined semantic identifiers. In this regard, aspects of the present invention are directed to employing the aforementioned information to interpret natural language queries to recall information related to computing device events associated with a user.

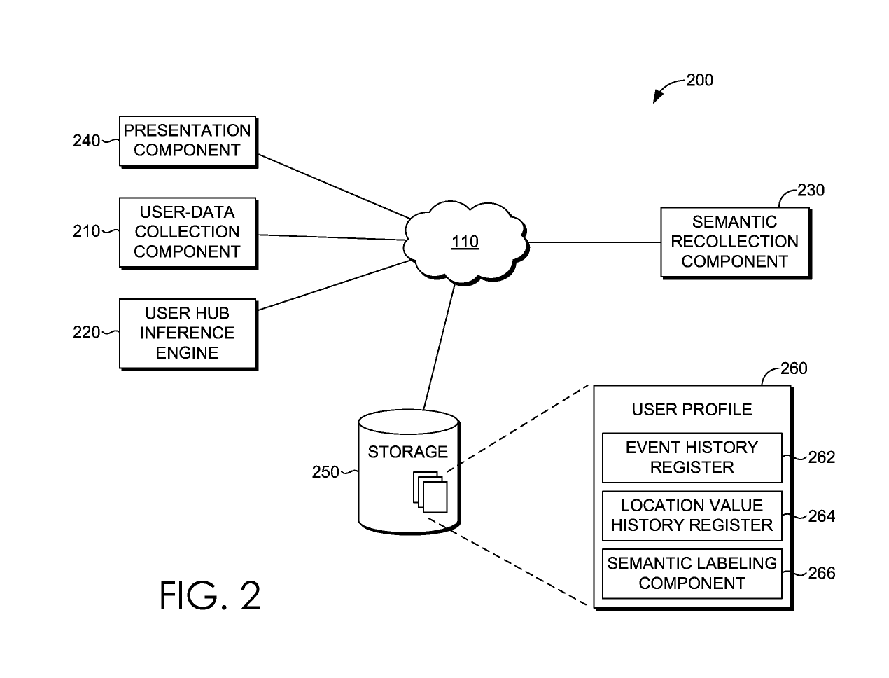

Accordingly, at a high level, in one embodiment, user data is received from one or more data sources. The user data may be received by collecting user data with one or more sensors or components on user device(s) associated with a user. Examples of user data, also described in connection to component 210 of FIG. 2, may include location information of the user's mobile device(s), user-activity information (e.g., app usage, online activity, searches, calls), application data, contacts data, calendar and social network data, or nearly any other source of user data that may be sensed or determined by a user device or other computing device. The received user data may be monitored and information about the user may be stored in a user profile, such as user profile 260 of FIG. 2. The received user data may also include temporal data (e.g., timestamps) associated therewith.

In one embodiment, a user profile 260 is utilized for storing user data about the user. User data can be collected only at times of user device events (e.g., when email is exchanged, text is exchanged, phone call is made/received, new location detected, etc.), periodically, or at all times (i.e., on an on-going basis), and can be analyzed for determining correlations between location values and location labels associated with the user. This user data can also be used to determine correlations between the location values and device events that occurred at the location values. Moreover, by analyzing the temporal data associated with the user data, correlations between location values, device events, and temporal data can be identified. To this end, semantic identifiers and/or natural language corresponding to these data points can be used to facilitate the recollection of information related to computing device events associated with a user.

A plurality of event records associated with the user may be determined from the received user data. In particular, the user data may be used to determine information about events that occur on one or more computing devices associated with the user. Computing device events may include any process that occurs on the one or more computing devices associated with the user. Typically, events are classified into categories, such as email, text, phone call, picture, video, opening and closing of file or application, location detection, and more. These events typically have an event identifier associated with the underlying process (i.e., in metadata or process identifiers), which can be used to identify or classify the type of event occurring.

Further, upon execution of the event process, timestamps are typically associated with the event. For instance, most computing systems include an event log that tracks all processes and timestamps associated with the processes. Similarly, each event sensed from the user data may include an associated timestamp. Events may further include additional event information associated therewith. For instance, an event typically has information about the event associated therewith, such as references to associated files, associated titles or words for the event, user friends associated with the event, etc. As such, each event sensed from the user data may include additional event information associated with the event.

In some embodiments, a plurality of location values associated with the user may also be determined from the received user data. In particular, the user data may be used to determine a historical record of location values sensed in association with the user. The location values may be determined based on user data associated with the user, as will be explained in more detail. In some aspects, each location value in the plurality of location values is a unique recording of the location value at a particular time. In more detail, each time a location value is requested and/or sensed, a new instance of the location value is recorded as a new entity and associated with a corresponding time. As such, each location value may include a corresponding timestamp that indicates a particular time the location value was sensed, as will be explained herein. In this regard, the plurality of location values may also include many instances of the same location value, each having a unique timestamp associated therewith. For example, if user data indicated that the user was at coordinates “47.642 −122.136” on “Thu Jul 31 13:45:51 2015”, “47.642 −122.136” on “Fri Aug 1 08:15:11 2015”, and “47.642 −122.136” on “Sat Aug 2 01:12:35 2015”, the user data would indicate that the user was at the coordinate location value “47.642 −122.136” on at least July 31 through August 2, during at least the respective times.

User data may also include a plurality of location labels, each corresponding to at least one of the plurality of location values associated with the user. In other words, the user data may include location labels for one or more location values associated with the user. In some embodiments, the location labels may only correspond to location values of particular relevance or importance to the user, for instance, if a particular location value is determined to be a user hub. In one aspect, a location label for any particular location value can be inferred and suggested to a user. For example, if a pattern of user activity sensed within user data is associated with a sensed location value during standard working hours (i.e., 9 A.M. to 5 P.M.), an inference can be made that the location value is associated with the location label “Work.” As such, a suggestion can be made to associate the location label “Work” in association with the location value, whereby the suggestion can then be denied or accepted by the user to establish an association between the location label and location value. In another aspect, a location label for any particular location value can be directly input by the user and associated with a location value.

Based on the aforementioned types of user data, a pool of data associated with a user is available for retrieving relevant event information arising out of a natural language event query. In more detail, the event query may require one or more proper parameters to be correctly interpreted by a search algorithm. The event query may include one or more proper parameters including: a keyword that references a type or classification of the event, a location label associated with where the event took place, and/or a temporal descriptor associated with the prior event. In some instances, the event query may require that all proper parameters are present in the event query in order to conduct a search. The event query may be constructed, by way of example only, “What was the ‘text message’ that I received while at ‘my favorite coffee shop’ last ‘Tuesday’?” In some other instances, the event query may only necessitate the presence of one or more of the proper parameters to conduct the search. For instance, and by way of example only, the event query may be “Show me the ‘picture I took’ while at ‘Times Square’.” An event query can be processed to narrow down a plurality of past events to identify a single event or a small subset of relevant events. In various embodiments, the result of processing the event query may retrieve data associated with one or more relevant events, or information related to the events, for communication to the user.

As was previously described, user data may also include a plurality of location values, i.e., a historical record, of location values sensed in association with the user. Based on the historical record of location values, one or more venues of interest or “user hubs” may be inferred for the user. In some embodiments, a clustering algorithm may be employed to analyze the user's historical location data by algorithmically mapping the location values to generate clusters for inferring potentially significant locations. In more detail, a user hub inference engine may determine, based on the location value history, that clusters of location values mapped by the clustering algorithm may infer a location of potential significance for the user. The user hub inference engine may further consider the number of unique location values (i.e., unique visits) within each cluster, in addition to other sensor data associated with the user, to compute a confidence score corresponding to each potentially significant location. To this end, a potentially significant location with a high confidence score may be inferred as a “user hub,” which may also be associated with location labels for semantic identification.

Some embodiments may include the employing of other users' data, the other users having a pre-defined relationship with a user. For instance, a user may have one or more friends that each has one or more associated computing devices also collecting individualized user data. Each user may establish, with one or more other users, a definitive relationship (i.e., a “friendship”) that may enable the cross-sharing of at least a portion of user data to facilitate the detection of inferences between each other's activities. By way of example only, assume that user John has established a definitive relationship with friends Jane and Sam. John typically watches a movie with Jane on Friday nights, while John typically plays racquetball with Sam on Saturday mornings. Simply by way of John's defined relationship with Jane and Sam as friends, an analysis of the individualized user data of John and Jane's detected presence at the movie theater on Friday night may infer that they were together. Similarly, due to John's pre-defined friendship with Sam, an inference may be made from their user data that they are together at the racquetball courts on Saturday mornings.

In some embodiments, a detection that a user is within the vicinity of a pre-defined friend can trigger an event. For instance, various applications may be operable to actively trigger (i.e., alert a user) or passively trigger an event when their detected location is determined to be within a certain proximity to a friend's detected location. In various embodiments, such an event in user data can similarly be logged as an event record, as was described above. Details about the event may include, by way of example only, an event identifier such as “proximity to friend,” event information such as the friend's name, a location value or label, and/or a timestamp. In this regard, a proper event query for recalling information about a past event when in proximity to a friend may be constructed, by way of example only, “‘Where’ did I meet ‘Jane’ ‘last week’?” In this example query, the parameters “where”, “Jane”, and “last week” may be used to narrow the possible past events from the plurality of user events. The temporal descriptor of “last week” may, for example, limit the search between timestamps beginning at 12:00:00 A.M. on the first day of the week and ending at 11:59:59 P.M. on the last day of the week. Moreover, again by way of example, the “proximity to friend” event identifier may be queried based on parameters referencing a known friend (i.e., Jane) and a location query, such as “where.” In this regard, a particular location from the user's location value history register corresponding with the query parameters may be retrieved for presentation to the user in response to the received event query.

In another aspect, it may not be necessary to generate and log events related to the detection of friend proximity. More specifically, due to the established relationship between friends, an event query including defined friend's name may initiate an analysis on the user's data and the friend's data, to determine correlations there between with regards to location and/or time. For instance, a query such as “What was the ‘picture I took’ when at ‘my favorite coffee shop’ ‘with Jane’ ‘last week’?” includes the friend parameter “Jane”, location parameter “my favorite coffee shop”, and temporal descriptor “last week.” As such, the query may limit the search for “picture taken” events occurring at location value associated with the location label “my favorite coffee shop” during the timeframe defined by “last week.” Moreover, the events may be narrowed down even further based on the “picture taken” events at times the user was “with Jane.” To narrow down these events, Jane's user data may be analyzed to determine times within the timeframe of “last week” that she was at the same location value (i.e., the coordinates defined by the user's favorite coffee shop). As such, one or more of the user's “picture taken” events may coincide with location values logged by Jane's location value history register, particularly indicating that Jane was at the same coffee shop at the same time and date as the user. To this end, search algorithms can utilize one or more user's data (i.e., friends) to determine correlations and inferences when processing event queries, as described.

As described, some embodiments include using user data from other users having a defined relationship with the user (i.e., crowdsourcing data) for determining relevance, confidence, and/or relevant supplemental content for making inferences in relationships, activities, or recalling past events. Additionally, some embodiments described herein may be carried out by a personalization-related application or service, which may be implemented as one or more computer applications, services, or routines, such as an app running on a mobile device or the cloud, as further described herein.

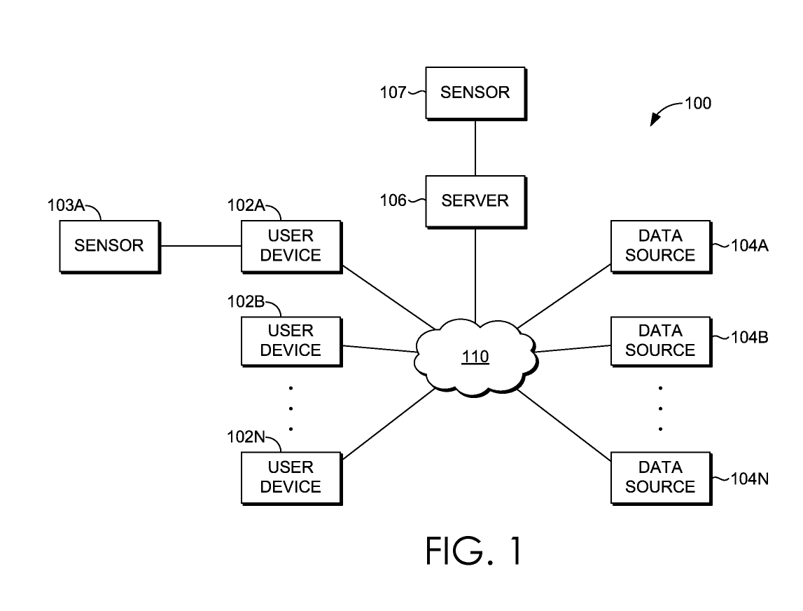

Turning now to FIG. 1, a block diagram is provided showing an example operating environment 100 in which some embodiments of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

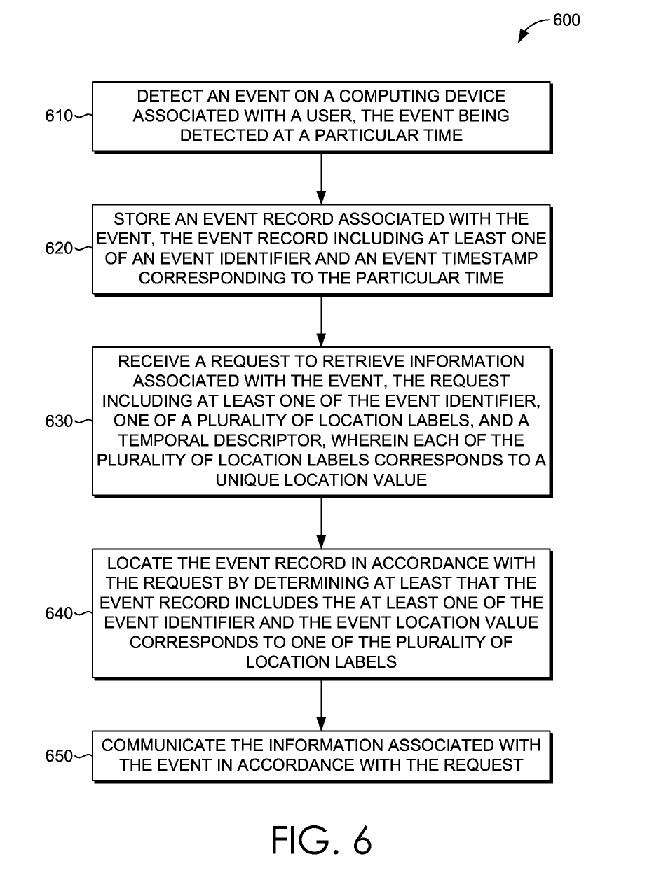

Among other components not shown, example operating environment 100 includes a number of user devices, such as user devices 102a and 102b through 102n; a number of data sources, such as data sources 104a and 104b through 104n; server 106; and network 110. It should be understood that environment 100 shown in FIG. 1 is an example of one suitable operating environment. Each of the components shown in FIG. 1 may be implemented via any type of computing device, such as computing device 600 described in connection to FIG. 6, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

It should be understood that any number of user devices, servers, and data sources may be employed within operating environment 100 within the scope of the present disclosure. Each may comprise a single device or multiple devices cooperating in a distributed environment. For instance, server 106 may be provided via multiple devices arranged in a distributed environment that collectively provide the functionality described herein. Additionally, other components not shown may also be included within the distributed environment.

User devices 102a and 102b through 102n can be client devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities.

User devices 102a and 102b through 102n may comprise any type of computing device capable of use by a user. For example, in one embodiment, user devices 102a through 102n may be the type of computing device described in relation to FIG. 6 herein. By way of example and not limitation, a user device may be embodied as a personal computer (PC), a laptop computer, a mobile or mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, or any combination of these delineated devices, or any other suitable device.

Data sources 104a and 104b through 104n may comprise data sources and/or data systems, which are configured to make data available to any of the various constituents of operating environment 100, or system 200 described in connection to FIG. 2. (For example, in one embodiment, one or more data sources 104a through 104n provide (or make available for accessing) user data to user-data collection component 210 of FIG. 2.) Data sources 104a and 104b through 104n may be discrete from user devices 102a and 102b through 102n and server 106 or may be incorporated and/or integrated into at least one of those components. In one embodiment, one or more of data sources 104a though 104n comprise one or more sensors, which may be integrated into or associated with one or more of the user device(s) 102a, 102b, or 102n or server 106. Examples of sensed user data made available by data sources 104a though 104n are described further in connection to user-data collection component 210 of FIG. 2.

Operating environment 100 can be utilized to implement one or more of the components of system 200, described in FIG. 2, including components for collecting user data, monitoring events, generating inferences, processing queries, and/or presenting past events and related content to users. Referring now to FIG. 2, with FIG. 1, a block diagram is provided showing aspects of an example computing system architecture suitable for implementing an embodiment of the present disclosure and designated generally as system 200. System 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

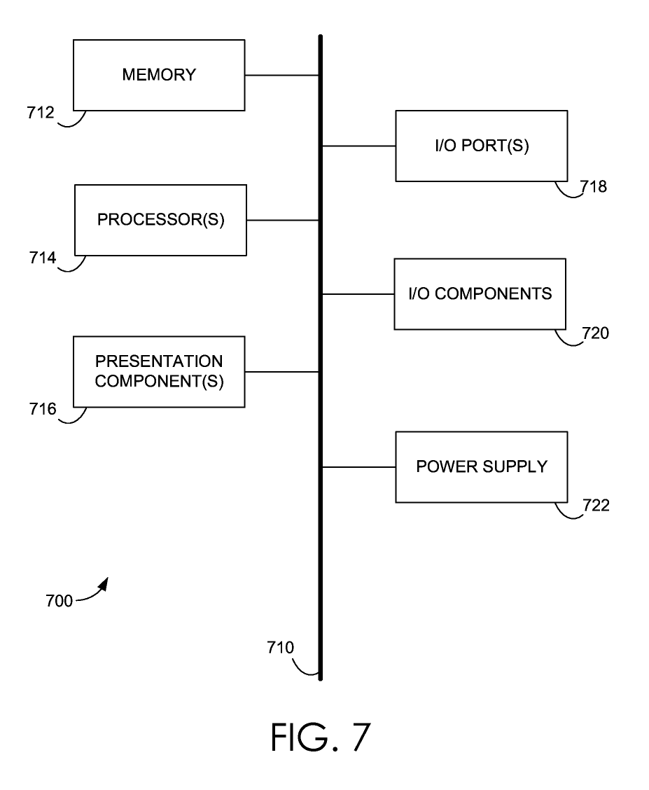

Example system 200 includes network 110, which is described in connection to FIG. 1, and which communicatively couples components of system 200 including user-data collection component 210, user hub inference engine 220, semantic recollection component 230, presentation component 240, and storage 250. The user data collection component 210, user hub inference engine 220, semantic recollection component, and presentation component 240 may be embodied as a set of compiled computer instructions or functions, program modules, computer software services, or an arrangement of processes carried out on one or more computer systems, such as computing device 700 described in connection to FIG. 7, for example.

In one embodiment, the functions performed by components of system 200 are associated with one or more personalization-related (e.g., “personal assistant”) applications, services, or routines. In particular, such applications, services, or routines may operate on one or more user devices (such as user device 102a), servers (such as server 106), may be distributed across one or more user devices and servers, or be implemented in the cloud. Moreover, in some embodiments, these components of system 200 may be distributed across a network, including one or more servers (such as server 106) and client devices (such as user device 102a), in the cloud, or may reside on a user device, such as user device 102a. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the embodiments described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 200, it is contemplated that in some embodiments functionality of these components can be shared or distributed across other components.

Continuing with FIG. 2, user-data collection component 210 is generally responsible for accessing or receiving (and in some cases also identifying) user data from one or more data sources, such as data sources 104a and 104b through 104n of FIG. 1. In some embodiments, user-data collection component 210 may be employed to facilitate the accumulation of user data of one or more users (including crowdsourced data) for, among other things, semantic recollection component 230. The data may be received (or accessed), and optionally accumulated, reformatted, and/or combined, by user-data collection component 210 and stored in one or more data stores such as storage 250, where it may be available to user hub inference engine 220 and/or semantic recollection component 230. For example, the user data may be stored in or associated with a user profile 260, as described herein.

The user profile 260 can include an event history register 262, a location value history register 264, and/or a semantic labeling component 266. The event history register 262 can be configured to store user event data, received from user-data collection component 210, as will be described in more detail herein. The location value history register 264 can be configured to store user location history in, for instance, a log of sensed location data (i.e., location coordinates). The semantic labeling component 266 can be configured to store a table or database of user location labels with corresponding location values. In other words, any semantic identifier approved or input by the user, as a reference to a physical location, can be stored in the semantic labeling component 266 with a corresponding location value. In this regard, each user may have a unique set of semantic identifiers for various location values. In some embodiments, any personally identifying data (i.e., user data that specifically identifies particular users) is either not uploaded from the one or more data sources with user data, is not permanently stored, and/or is not made available to user hub inference engine 220 and/or semantic recollection component 230.

User data may be received from a variety of sources where the data may be available in a variety of formats. For example, in some embodiments, user data received via user-data collection component 210 may be determined via one or more sensors (such as sensors 103a and 107), which may be on or associated with one or more user devices (such as user device 102a), servers (such as server 106), and/or other computing devices. As used herein, a sensor may include a function, routine, component, or combination thereof for sensing, detecting, or otherwise obtaining information such as user data from a data source 104a, and may be embodied as hardware, software, or both. By way of example and not limitation, user data may include data that is sensed or determined from one or more sensors (referred to herein as sensor data), such as location information of mobile device(s), smartphone data (such as phone state, charging data, date/time, or other information derived from a smartphone), user-activity information (for example: app usage; online activity; searches; voice data such as automatic speech recognition; activity logs; communications data including calls, texts, instant messages, and emails; website posts; other user data associated with communication events; etc.) including user activity that occurs over more than one user device, user history, session logs, application data, contacts data, calendar and schedule data, notification data, social network data, news (including popular or trending items on search engines or social networks), online gaming data, ecommerce activity (including data from online accounts such as Microsoft®, Amazon.com®, Google®, eBay®, PayPal®, video-streaming services, gaming services, or Xbox Live®), user-account(s) data (which may include data from user preferences or settings associated with a personalization-related (e.g., “personal assistant”) application or service, home-sensor data, appliance data, global positioning system (GPS) data, vehicle signal data, traffic data, weather data (including forecasts), wearable device data, other user device data (which may include device settings, profiles, network connections such as Wi-Fi network data, or configuration data, data regarding the model number, firmware, or equipment, device pairings, such as where a user has a mobile phone paired with a Bluetooth headset, for example), gyroscope data, accelerometer data, payment or credit card usage data (which may include information from a user's PayPal account), purchase history data (such as information from a user's Amazon.com or eBay account), other sensor data that may be sensed or otherwise detected by a sensor (or other detector) component including data derived from a sensor component associated with the user (including location, motion, orientation, position, user-access, user-activity, network-access, user-device-charging, or other data that is capable of being provided by one or more sensor component), data derived based on other data (for example, location data that can be derived from Wi-Fi, cellular network, or IP address data), and nearly any other source of data that may be sensed or determined as described herein. User data may be provided in user-data streams or “user signals”, which can be a feed or stream of user data from a data source. For instance, a user signal could be from a smartphone, a home-sensor device, a GPS device (e.g., for location coordinates), a vehicle-sensor device, a wearable device, a user device, a gyroscope sensor, an accelerometer sensor, a calendar service, an email account, a credit card account, or other data sources. In some embodiments, user-data collection component 210 receives or accesses data continuously, periodically, or as needed.

User data, particularly in the form of event data and/or location data can be received by user-data collection component 210 from one or more sensors and/or computing devices associated with a user. While it is contemplated that the user data is processed, by the sensors or other components not shown, for interpretability by user-data collection component 210, embodiments described herein do not limit the user data to processed data and may include raw data. Event data and location data may be received on a higher level, for instance, from individual applications, or on a lower level, for instance, from operating systems. Operating systems such as Microsoft® Windows®, Apple® iOS®, Google® Android®, etc., may be operable to collect event data and associate the event data with the user. Typically, operating systems can be configured to associate with a user account. In the alternative, applications running on operating systems may independently associate with the user account, or may inherit associations with the user account through the operating system on which it resides. The event data can be accessed by user-data collection component 210, configured to interface with the application(s) or operating system(s), among other things, to request and/or receive the user's event data therefrom. In some embodiments, user-data collection component 210 can operate independently within the user's computing device(s) to receive the user event data.

In some embodiments, user-data collection component 210 or one or more other components or subcomponents of system 200, may determine interpretive data from received user data. Interpretive data corresponds to data utilized by these components or subcomponents to interpret user data. For example, interpretive data can be used to provide other context to user data, which can support determinations or inferences made by the components or subcomponents. Moreover, it is contemplated that some embodiments may use user data and/or user data in combination with interpretive data for carrying out the objectives of the components and subcomponents described herein.

In various embodiments, the event and/or location data associated with a user, among other things, can be stored in a user profile 260. In some aspects, the event data can be stored in the event history register 262, including details related to each event that occurs on one or more computing devices associated with the user. The event history register 262 may include event identifiers, references to associated files or data, timestamps, and more. In another aspect, the location data can be stored in the location value history register 264, including a log of location values sensed by one or more computing devices associated with the user. The location value history register 264 may include, among other things, location values and timestamps associated with when the location value was sensed.

User hub inference engine 220 is generally responsible for analyzing user data, either on a continuing basis or on an interval basis, to identify location values that may be of particular relevance to the user. As described previously, user data may include a plurality of location values received from user-data collection component 210. In some embodiments, the user data and/or information about the user determined from the user data is stored in a user profile, such as user profile 260. Based on the historical record of location values, one or more venues of interest or “user hubs” may be inferred for the user. In some embodiments, a clustering algorithm may be employed to analyze the user's historical location data by algorithmically mapping the location values to generate clusters for inferring potentially significant locations. In some other embodiments, the clustering algorithm may be employed to analyze not only the user's historical location data, but also a plurality of users' historical location data, by similarly mapping the location values to generate clusters for inferring potentially significant locations. In this regard, historical location data from users having defined relationships (e.g., friends, coworkers, common meeting invitees, etc.) may all be considered, in aggregate, to infer potentially significant locations. In further embodiments, the user hub inference engine 220 can employ “world knowledge” when inferring potentially significant locations. For instance, world knowledge may include, among other things, map data, yellow page identifiers (YPIDs) associated with locations, and other data sources associated with venues or locations of general interest.

In more detail, the user hub inference engine 220 may determine that clusters of location values mapped by the clustering algorithm infer a location of potential significance for the user based on data stored in the location value history, which may be stored in the location value history register 262 of user profile 260. The user hub inference engine 220 may further consider the number of specific location values, corresponding to unique user visits, within each cluster, in addition to other sensor data associated with the user, to compute a confidence score corresponding to each potentially significant location. In this regard, a potentially significant location with a high confidence score may be determined as a “user hub,” which may also be associated with location labels (for instance, in semantic labeling component 266) for semantic identification. In some embodiments, one or more location values determined to be a user hub can be stored as such in the user profile 260. For instance, a subset of location values immediately surrounding a physical or logical location may each be associated with a user hub.

As was described, the user hub inference engine 220 can be configured to analyze the location values associated with a user by employing, by way of example only, a clustering algorithm. Although embodiments herein describe the employment of a clustering algorithm, other methods of data analysis are considered within the scope of the present disclosure. The clustering algorithm can be employed to plot the coordinate values for each of the location values being analyzed. In some embodiments, only location values collected within a defined timeframe may be analyzed. In other embodiments, all collected location values associated with a user can be analyzed. In more detail, if a history of location values for the user was being analyzed, the clustering algorithm can plot each of the coordinate values and determine, based on cluster density, a probable location of interest to either prompt the user about a detected user hub or log the location of interest for recollection at a later time. To this end, if a probable user hub is detected and the user accepts the location as a user hub, the user can associate the user hub with a location label, which can then be stored in the user profile 260.

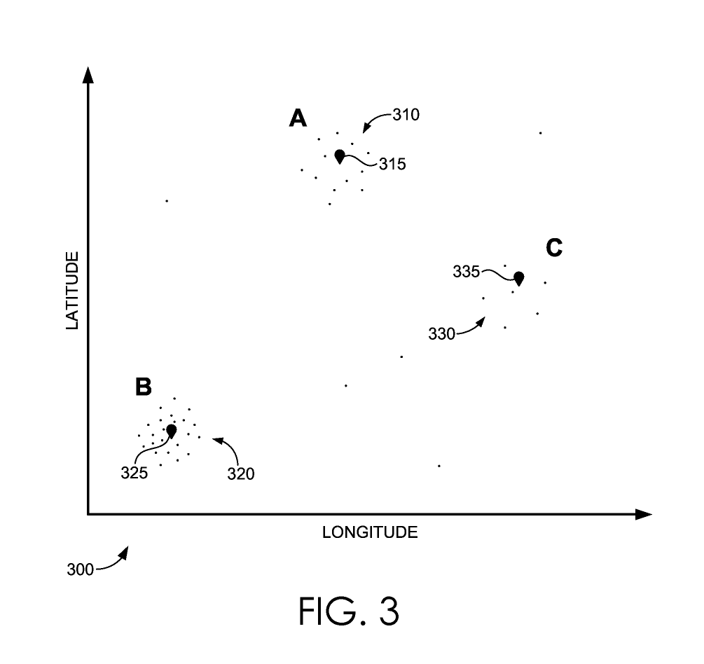

The clustering algorithm can be useful for detecting probable user hubs based on one or more location values recorded in the location value history register 264. Looking now to FIG. 3, an exemplary coordinate map 300 having a plurality of plotted location values is illustrated. As was described, plotting of the coordinate values can be conducted on a coordinate map that corresponds to at least one of the location values. For instance, if the coordinate values are each in standard GPS form, then the coordinate map for plotting will include a standard GPS coordinate system. Similarly, if the location value is a physical address of the meeting location, it is contemplated that a conversion to the common coordinate system is performed on the physical address. To this end, if any one or more coordinate values are from a different coordinate system, the one or more coordinate values can be converted to a common coordinate system that can be plotted on the coordinate map for analysis. While the term “map” is used herein, it is contemplated that the map is merely a virtual map or a data structure employed by the clustering algorithm for facilitating the virtual representation of meeting location values that are analyzed for determining cluster density, as will be described.

Cluster density can be determined for a group of approximate data points (e.g., location values) on a coordinate map. By way of example only, if a plurality of location values (e.g., Cluster A 310) were grouped around Location A 315: (e.g., 47.647142, −122.123283), and another plurality of location values (e.g., Cluster B 320) were grouped around Location B 325: (e.g., 47.639742, −122.128373), a cluster density can be determined for each of Clusters A 310 and B 320, based on the number of data points (e.g., location values) that are proximate to one another in each cluster. Clusters will typically populate around specific physical locations, such as a building, structure, venue, shop, park, or other geographic location, including an area or region.

The user hub inference engine 220 can further analyze the one or more clusters 310, 320 to determine a confidence score that a cluster is actually a user hub. A confidence score may be calculated for each cluster analyzed by the user hub inference engine 220. The confidence score may be impacted by various factors, such as the variance in the clusters plotted by the user hub inference engine 220, the age of each detected location value forming the clusters, the number of location values forming the clusters, visitation patterns detected within the clusters (i.e., weekend, nighttime, en route patterns) through timestamp analysis, distances between clusters and the user's home or work, density of Wi-Fi signals detected and recorded in association with each location value in the clusters, visit durations associated with each location value in the clusters (also employing timestamp analysis), and more.

In some embodiments, the size or relative number of data points for each cluster can be a major factor in determining a confidence score for a cluster being evaluated as a potential user hub. By way of example only, coordinate map 300 of FIG. 3 illustrates Clusters A 310, B 320, and C 330. Assuming that Cluster A 310 has seventy-five data points, Cluster B 320 has twenty data points, and Cluster C 330 has five data points, a confidence score can be determined for each of Cluster A 310, Cluster B 320, and/or C 330. In some embodiments, a relative density, among other factors, can be compared to a predetermined threshold (e.g., 0.6) to determine that a particular cluster is a user hub. When a cluster is determined by the user hub inference engine 220 to be a probable user hub, the user hub inference engine 220 is configured to return a location value associated with the cluster to the user for confirmation thereof, for instance, through presentation component 240. As such, and by way of example only, the coordinates corresponding to Cluster A 310, Cluster B 320, and/or C 330 can be returned by the user hub inference engine 220 based on the analysis conducted thereby.

Semantic recollection component 230 is generally responsible for receiving and/or processing an event query or the query parameters thereof. Although not illustrated, the parameters received from the event query may be received from a speech conversion engine on the one or more computing devices. For instance, a user may construct an event query by speaking the query terms in natural language (i.e., “What was the name of the restaurant I ate at with Jane yesterday?”). As such, the spoken event query may be converted into text, via a speech conversion engine, and subsequently processed by the semantic recollection component 230. While the processing of speech is not limited to event queries, discussions related to processing spoken event queries are limited to the semantic recollection component 230 for purposes of the present disclosure. The functions of speech conversion engine (not shown) can be part of system 200 and may be associated with one or more personalization-related (e.g., “personal assistant”) applications, services, or routines. In particular, such applications, services, or routines may operate on one or more user devices (such as user device 102a), servers (such as server 106), and may be distributed across one or more user devices and servers, or be implemented in the cloud, as was described with respect to other features of system 200.

The processing of event queries and its parameters may include analyzing user data, for instance, user data stored in user profile 260. Analysis of data may include searching user data in the event history register 262, location value history register 264, and/or the semantic labeling component 264, and analyzing the data to extrapolate correlations based on at least one of the parameters of the event query. For instance, event query parameters may include at least a temporal parameter, such as “last week”, “yesterday”, or “the other day.” As such, and by way of example only, data from the event history register 262 may be filtered down to those event records having timestamps that fall within one of these temporal descriptors.

In another instance, event query parameters may include at least a location label. As such, and by way of another example, a corresponding location value may be extracted from the semantic labeling component 264. To this end, the corresponding location value can further filter data from the location value history register 264 to determine one or more possible times that the user was at the location value, or alternatively, may filter data from the event history register 262 to determine one or more possible events that occurred at a time substantially similar to a timestamp associated with the recorded location value. In another instance, event query parameters may include at least an event identifier. As such, and by way of example only, an event identifier can filter data from the event history register 262 to determine one or more potential events having a classification associated with the event identifier (i.e., an email, a text, a phone call, etc.).

It is contemplated that any one of these parameters, such as event identifiers, temporal descriptors, or location labels, can be searched independently or in combination, to identify one or more potential search results. It is also appreciated that a greater number of search parameters may result in a narrower search result and, preferably, a single search result will be presented to the user through presentation component 240. While not intended to be limiting, it is further contemplated that principles similarly employed in the normalization of relational databases may be employed for the analysis and searching of data described in the present disclosure.

In some embodiments, presentation component 240 generates user interface features associated with a search result. Such features can include interface elements (such as graphics buttons, sliders, menus, audio prompts, alerts, alarms, vibrations, pop-up windows, notification-bar or status-bar items, in-app notifications, or other similar features for interfacing with a user), queries, and prompts. For example, presentation component 240 may prompt the user for an event-related query, among other things. In another instance, the presentation component 240 may appear dormant, while ready to receive and respond to event-related queries communicated thereto. Some embodiments of presentation component 240 capture user event queries and provide this information to semantic recollection component 230 directly or by way of a speech conversion engine (not shown).

As described previously, in some embodiments, a personalization-related service or application operating in conjunction with presentation component 240 determines when and how to present the search result. In such embodiments, the search result may be understood as a recommendation to the presentation component 240 (and/or personalization-related service or application) for when and how to present the search result, which may be overridden by the personalization-related app or presentation component 240. For instance, if the search result for example event query “What was the picture I took at Jane's house yesterday?” resulted in a single image, it is contemplated that, by way of example, the single image result may automatically be displayed by the presentation component 240 in response to the event query. In another example, if the search result for example event query “What was the name of the restaurant I ate at with John last week?” resulted in a single location label or value, it is contemplated that, by way of example, a restaurant review or a map displaying the restaurant name and location is automatically displayed by the presentation component 240 in response to the event query. In some other embodiments, where one or more search results are derived from the event query, it is contemplated that the presentation component 240 may present a graphical representation of the one or more search results for individual selection by the user. For instance, if several pictures were taken at Jane's house, as in the earlier example, the presentation component 240 may present thumbnails of the images in response to the event query. It is contemplated that the aforementioned examples may be applied to all types of events described in the present disclosure, including texts, emails, phone calls, colocation of contacts/friends, URLs, attachments, files, sensed locations, and the like.

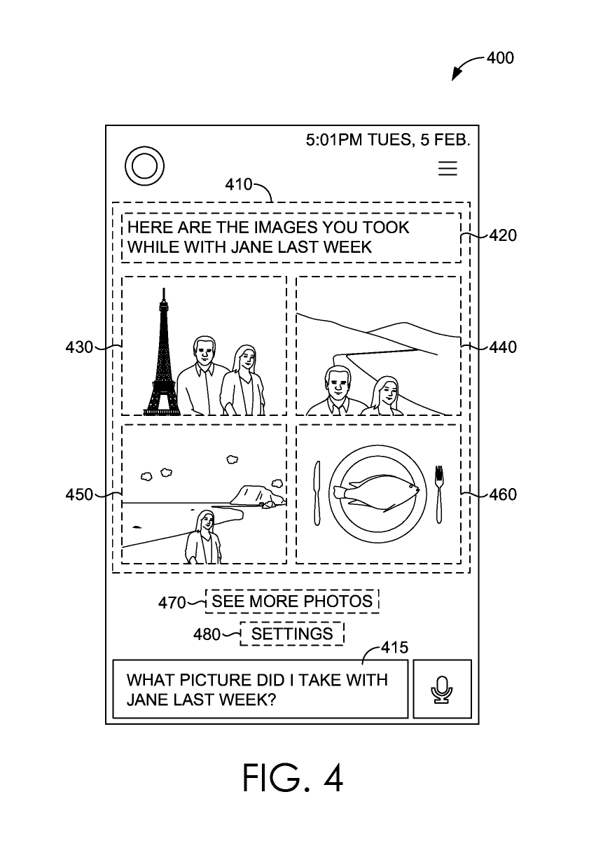

Turning now to FIG. 4, an example of a search result generated in response to and based on a received event query is described. In this example, the information is collected from a library of images accessible from the user device. The information is relevant to the user because the user is interested in finding images that were taken by him under particular circumstances, as will be described.

FIG. 4 depicts an example user interface of a user device (not shown) having a number of elements for providing content associated with an exemplary search result generated by presentation component 240, and is referenced generally as user interface 400. In this example, user interface 400 comprises a graphical user interface on a user device, such as a smartphone. Example user interface 400 depicts one example of a search result 410 presented to a user in accordance with an embodiment of the invention. The search result 410 includes an initial response to the received event query 415, repeating at least some parameters received as part of the event query. In this particular example, the user input an event query seeking images that the user took while with his friend Jane last week. The search result 410 indicates, in response to the received event query, that the images taken while the user was with Jane last week are being presented.

With continuing reference generally to FIG. 4, search result content or information may be generated by semantic recollection component 230 and used by presentation component 240 for preparing the search result 410. In one embodiment, the search result generated by semantic recollection component 230 may be formatted in a markup language, tagged, or indexed to indicate how specific portions of the content are to be used by presentation component 240. For instance, in one embodiment, the search result 410 may include a tagged response message 420, such as “<RESPONSE> Here are the images you took while with Jane last week. </RESPONSE>.” Other portions of search result 410 content may be marked up or tagged in a similar fashion so as to indicate how the result content data and/or logic should be applied.

In various embodiments, the user interface 400 may further include one or more search results based on the event query 415. As was described, search results 410 may include data from one or more event records meeting the criteria defined by parameters of the event query. In some embodiments, where only one search result is derived from the event query, the user interface 400 may be configured to present the one search result in more detail. For instance, if only one image was determined to meet the parameters defined by the event query 415, then presentation component 240 may be configured to display the image with greater detail (i.e., in full screen or with additional metadata). In other embodiments, more than one search result may be derived from the event query. In such instances, the user interface 400 may be configured to present each search result as a selectable item, as illustrated by search result thumbnails 430, 440, 450, and 460. In this regard, one or more of the search results may be selected by the user to receive more detail about the one or more event records associated therewith, or to perform actions on the one or more event records.

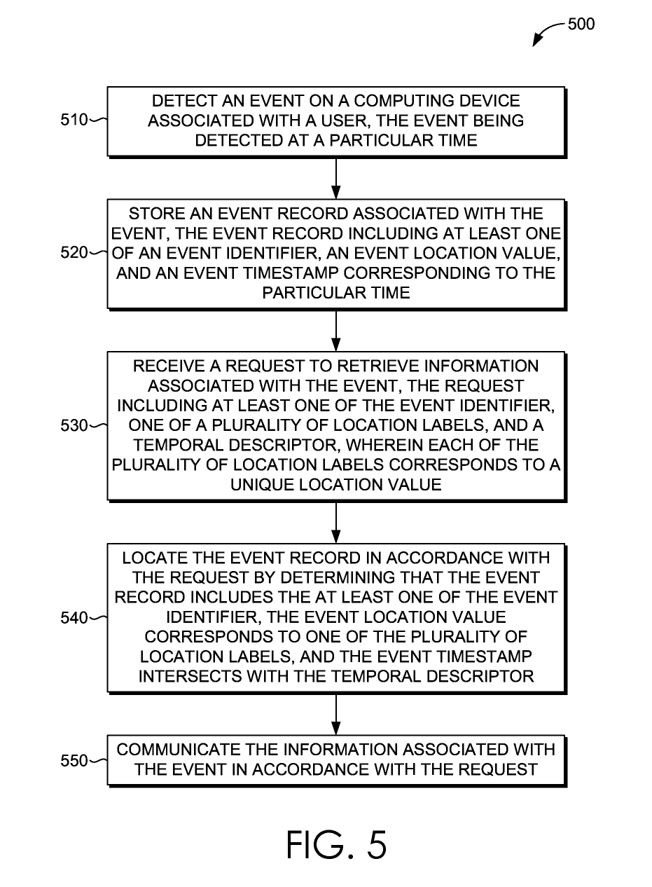

User interface 400 may further include one or more other control options, such as a settings control item 480 or a see-more item 470. Settings control item 480 may provide the user with options to set a variety of user preferences, which may be stored in user profile 260. User preferences may include, for instance, settings associated with search results, event types to be considered in received event queries, preferred formats for search result presentation, information sources, and the like. In some embodiments, settings control item 480 may enable a user to view and/or modify default settings or learned settings. The See-more item 470 can be configured to see additional search results or, in some embodiments, may be configured to provide the user with additional information about the currently-presented search results. As was described, the above example is merely exemplary and not intended to be limiting. It is contemplated that the search results may include events and information related thereto of any type, as described in the present disclosure. Turning now to FIG. 5, a flow diagram is provided illustrating one example method 500 for recalling information related to past computing device events. Each block or step of method 500 and other methods described herein comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a stand-alone application, a service or hosted service (stand-alone or in combination with another hosted service), or a plug-in to another product, to name a few.

At step 510, an occurrence of an event occurring on at least one computing device associated with a user is detected. Embodiments of step 510 may occur over an extended duration of time, such that a plurality of events is collected over time, with each event corresponding to a unique process occurring on the user's at least one computing device. Each event can be sensed by a plurality of computing devices and/or sensors associated with a user.

At step 520, an event record is stored in association with each event occurring on the at least one computing device associated with the user. The event record can include at least one of event information, an event identifier, an event location value, an event timestamp, and other event-related files and/or data. As was described herein, event information may include at least some parts of any or all of the aforementioned. In embodiments, the event location value can be based at least in part on sensor data received by the computing device. The event timestamp can also correspond to a particular time that the event occurred or was detected by the computing device(s) and/or sensor(s).

At step 530, a request to retrieve at least parts of the event record associated with the event is received. The request may include at least the event identifier, one of a plurality of location labels, and a temporal descriptor. As described within the scope of the present disclosure, a location label can corresponding to a unique location value, which may also be stored in the semantic labeling component 266 of FIG. 2.

At step 540, the event or record thereof is located in accordance with the request received at step 530. By employing the semantic recollection component 230 of FIG. 2, user data corresponding to at least one of the event identifier, the temporal descriptor, and the event location value corresponding to a location label (i.e., of semantic labeling component 266) is identified. The temporal descriptor can define parameters from which event records and/or location values, among other things, can be delimited or filtered when conducting searches on the user data, as described within the scope of the present disclosure.

At step 550, at least parts of the event record associated with the event in accordance with the event identifier, temporal descriptor, and/or one of the pluralities of location labels is communicated to another component of the system for processing or presentation, or communicated to the user through an output interface (i.e., a visual display or audible speaker).

With reference now to FIG. 6, a flow diagram is provided illustrating one example method 500 for recalling information related to past computing device events. At step 610, an occurrence of an event occurring on at least one computing device associated with a user is detected at a particular time. Embodiments of step 610 may occur over an extended duration of time, such that a plurality of events is collected over time, with each event corresponding to a unique process occurring on the user's at least one computing device. Each event can be sensed by a plurality of computing devices and/or sensors associated with a user.

At step 620, an event record is stored in association with each event occurring on the at least one computing device associated with the user. The event record can include at least one of event information, an event identifier, an event location value, an event timestamp, and other event-related files and/or data. As was described herein, event information may include at least some parts of any or all of the aforementioned. In embodiments, the event location value can be based at least in part on sensor data received by the computing device. The event timestamp can also correspond to a particular time that the event occurred or was detected by the computing device(s) and/or sensor(s).

At step 630, a request to retrieve at least parts of the event record associated with the event is received. The request may include at least the event identifier, one of a plurality of location labels, and a temporal descriptor. As described within the scope of the present disclosure, a location label can corresponding to a unique location value, which may also be stored in the semantic labeling component 266 of FIG. 2.

At step 640, the event or record thereof is located in accordance with the request received at step 630. By employing the semantic recollection component 230 of FIG. 2, user data corresponding to at least one of the event identifier, the temporal descriptor, and the event location value corresponding to a location label (i.e., of semantic labeling component 266) is identified. The temporal descriptor can define parameters from which event records and/or location values, among other things, can be delimited or filtered when conducting searches on the user data, as described within the scope of the present disclosure.

At step 650, at least parts of the event record associated with the event in accordance with the event identifier, temporal descriptor, and/or one of the pluralities of location labels is communicated to another component of the system for processing or presentation, or communicated to the user through an output interface (i.e., a visual display or audible speaker).

With reference now to operating environment 100, system 200, example user interface 400, and methods 500 and 600 (FIGS. 1-2 and 4-6), several additional examples are described for providing personalized computing experiences to a user based on semantic location information associated with user-related activity. These examples may be carried out using various embodiments of the disclosure described herein. In a first example, a user provides a natural language event query, such as “What was the website I visited while eating lunch at Joes' Cafeteria last week?” In this example, parameters for a search algorithm may include an event type or classification parameter (e.g., a ‘website’ visited or browsed), a location label associated with where the event took place (e.g., ‘Joes Cafeteria’), and a temporal descriptor parameters (‘last week’ and ‘lunch’ time, which may be interpreted, using rules or logic, as a particular timeframe, such as during the middle of the day, between 11 AM and 2 PM, or another time when the user typically eats lunch.)

In a second example, a user asks “What songs did I listen to the last time I ran at the park?,” where proper parameters might include an event type (e.g., songs played on a computing device associated with the user); a location label (e.g. “the park,” which in some instances may correspond to a geographical area or region rather than a specific geographical coordinate; and a temporal parameter (e.g. the last time the user was at the location label). In some circumstances, where the user has listened to songs in more than one park, the user may be prompted to provide clarification regarding the parameters, such as “OK, do you mean Central Park or High Line Park?” In a similar example, a user's request may be in the format of a command, rather than a query such as “Play song list I listened to the last time I ran in the park.” The proper parameters may be identified and used in a search algorithm in a similar manner, only rather than displaying a listing of songs identified from the query, the computer device may begin to play a first song from the query results.

In a third example, a user asks “Did I burn more calories today at the gym or when I ran at the park last week?” This example represents a complex query that may be interpreted by a search algorithm as a first query regarding calories burned (an event type, which may be determined using user data from a fitness tracker type computing device) today (a temporal descriptor) at the gym (a location label), and a second query regarding calories burned (an event type) last week (a temporal descriptor) at the park (a location label). The user may be presented with information derived from the results of both queries; namely the location label where the user burned more calories.

In a fourth example, a user asks “What was the song playing on John's phone while we were at dinner?” This example includes employing user date from other users having a pre-defined relationship with the particular user. Here, proper parameters may include a song played (event type) while at dinner with John (a temporal descriptor), the keywords ‘John's phone,’ which are related to the event type (i.e. “song playing on John's phone.” Thus in some embodiments, the event may be interpreted as a song that played on John's phone. Additionally, in some embodiments, John may need to preauthorize such functionality, which may be implemented as a privacy setting.)

In a fifth example, a user asks ‘what was the weather like the last time I visited Atlanta. Here, example proper parameters might include ‘the weather’ (an event type); ‘Atlanta’ (a location label, which corresponds to a geographical region rather than a specific geographical coordinate), and ‘the last time I visited’ (temporal parameter).

Accordingly, we have described various aspects of technology directed to recalling information related to past computing device events. It is understood that various features, sub-combinations, and modifications of the embodiments described herein are of utility and may be employed in other embodiments without reference to other features or sub-combinations. Moreover, the order and sequences of steps shown in the example methods 500 and 600 are not meant to limit the scope of the present invention in any way, and in fact, the steps may occur in a variety of different sequences within embodiments hereof. Such variations and combinations thereof are also contemplated to be within the scope of embodiments of the invention.

Having described various embodiments of the invention, an exemplary computing environment suitable for implementing embodiments of the invention is now described. With reference to FIG. 7, an exemplary computing device is provided and referred to generally as computing device 700. The computing device 700 is but one example of a suitable computing environment and is not intended to suggest any limitation as to the scope of use or functionality of the invention. Neither should the computing device 700 be interpreted as having any dependency or requirement relating to any one or combination of components illustrated.

Embodiments of the invention may be described in the general context of computer code or machine-useable instructions, including computer-useable or computer-executable instructions, such as program modules, being executed by a computer or other machine, such as a personal data assistant, a smartphone, a tablet PC, or other handheld device. Generally, program modules, including routines, programs, objects, components, data structures, and the like, refer to code that performs particular tasks or implements particular abstract data types. Embodiments of the invention may be practiced in a variety of system configurations, including handheld devices, consumer electronics, general-purpose computers, more specialty computing devices, etc. Embodiments of the invention may also be practiced in distributed computing environments where tasks are performed by remote-processing devices that are linked through a communications network. In a distributed computing environment, program modules may be located in both local and remote computer storage media including memory storage devices.

With reference to FIG. 7, computing device 700 includes a bus 710 that directly or indirectly couples the following devices: memory 712, one or more processors 714, one or more presentation components 716, one or more input/output (I/O) ports 718, one or more I/O components 720, and an illustrative power supply 722. Bus 710 represents what may be one or more busses (such as an address bus, data bus, or combination thereof). Although the various blocks of FIG. 7 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 7 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 7 and with reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 700. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors 714 that read data from various entities such as memory 712 or I/O components 720. Presentation component(s) 716 presents data indications to a user or other device. Exemplary presentation components include a display device, speaker, printing component, vibrating component, and the like.

The I/O ports 718 allow computing device 700 to be logically coupled to other devices, including I/O components 720, some of which may be built in. Illustrative components include a microphone, joystick, game pad, satellite dish, scanner, printer, wireless device, etc. The I/O components 720 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

Some embodiments of computing device 700 may include one or more radio(s) 724 (or similar wireless communication components). The radio 724 transmits and receives radio or wireless communications. The computing device 700 may be a wireless terminal adapted to receive communications and media over various wireless networks. Computing device 700 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Embodiments of the present invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A system having a processor, and memory with computer-executable instructions embodied thereon that, when executed by the processor, performs a method for recalling information related to past computing device events, the system comprising:
one or more sensors configured to provide sensor data;
an event history register configured to store a plurality of event records, each event record corresponding to one of a plurality of events occurring on a computing device associated with a user, each event record also including event information, an event identifier, and an event timestamp;
a location value history register configured to record a plurality of location values based at least in part on the sensor data, each location value including at least a location timestamp;
a semantic labeling component configured to reference each of a plurality of location labels with at least one of the plurality of location values in the location value history register;
a semantic recollection component configured to employ the location value history register, the semantic labeling component, and the event history register, to retrieve a particular event record from the event history register based on a received event query;
one or more processors;
one or more computer storage media storing computer-useable instructions that, when used by the one or more processors, cause the one or more processors to perform operations comprising:
retrieving, using the semantic recollection component, the event information for the particular event record corresponding to a particular received event query.

2. The system of claim 1, wherein the particular received event query comprises a particular event identifier, a particular location label, and a particular temporal descriptor,
wherein when retrieving the event information for the particular event record corresponding to the received event query, the particular temporal descriptor defines a duration wherein both the event timestamp and the location timestamp intersect.

3. The system of claim 1, wherein the event identifier is at least one of a predefined plurality of semantic reference terms used for classifying events.

4. The system of claim 1, wherein each event timestamp corresponds to a time that one of the plurality of events occur on the computing device.

5. The system of claim 1, wherein each location value is a location coordinate associated with the computing device.

6. The system of claim 1, wherein the location timestamp corresponds to a time associated with at least a portion of the sensor data received from the one or more sensors.

7. The system of claim 1, wherein the each of the plurality of location labels comprises a semantic location identifier.

8. The system of claim 6, wherein the semantic location identifier is either suggested to the user based at least on the sensor data and subsequently confirmed by the user, or is provided independently by the user.

9. The system of claim 1, further comprising a user hub inference engine configured to analyze the location value history register to generate one or more location clusters based on the plurality of location values stored therein, each location cluster comprising at least a portion of the plurality of location values recorded in the location value history register, and infer one or more user hubs based on the one or more generated location clusters, each of the one or more user hubs referencing a location value from the location value history register.

10. The system of claim 9, wherein the user hub inference engine infers the one or more user hubs by analyzing at least a quantity of location values within each of the one or more generated location clusters.

11. The system of claim 10, wherein the user hub inference engine infers the one or more user hubs by further analyzing sensor data.

12. The system of claim 9, wherein the user hub inference engine is further configured to store, in the semantic labeling component, the one or more user hubs, the semantic labeling component referencing one of the plurality of location labels with each of the one or more user hubs.

13. A computer-implemented method for recalling information related to past computing device events, the method comprising:
detecting an occurrence of an event occurring on a computing device associated with a user, the event being detected at a particular time;
storing an event record associated with the event, the event record including at least event information, an event identifier, an event location value based at least in part on sensor data received by the computing device, and an event timestamp corresponding to the particular time;
receiving a request to retrieve the event information associated with the event, the request including at least the event identifier, one of a plurality of location labels, and a temporal descriptor, wherein each of the plurality of location labels corresponds to at least one unique location value;
locating the event in accordance with the request by determining that the event record includes the event identifier, the event timestamp intersects with the temporal descriptor, and the event location value corresponds to the one of the plurality of location labels; and
communicating the event information associated with the event in accordance with the event identifier, the temporal descriptor, and the one of the plurality of location labels.

14. The media of claim 13, wherein the event identifier is one of a predefined plurality of semantic reference terms for classifying events.

15. The media of claim 13, wherein the location value also corresponds to the particular time.

16. The media of claim 13, wherein the location value is a location coordinate associated with the computing device.

17. The media of claim 13, wherein each of the plurality of location labels further corresponds to one of a plurality of user hubs, each user hub being based on at least one of a user location value history and sensor data associated with the user.

18. The media of claim 13, wherein the temporal descriptor defines a temporal parameters with which the event timestamp intersects.

19. The media of claim 18, wherein the temporal parameters are defined by at least one of a time, a date, a day of week, a year, a month, a season, and a temporal range.

20. One or more computer storage media having computer-executable instructions embodied thereon that, when executed by one or more processors, causes the one or more processors to perform a method for recalling information related to past computing device events, the method comprising:
detecting an occurrence of an event occurring on a computing device associated with a user, the event being detected at a particular time;
storing an event record associated with the event, the event record including at least event information, an event identifier, an event location value based at least in part on sensor data received by the computing device, and an event timestamp corresponding to the particular time;
receiving a request to retrieve the event information associated with the event, the request including at least the event identifier, one of a plurality of location labels, and a temporal descriptor, wherein each of the plurality of location labels corresponds to a unique location value;
locating the event in accordance with the request by determining that the event record includes the event identifier, the event timestamp intersects with the temporal descriptor, and the event location value corresponds to the one of the plurality of location labels; and
communicating the event information associated with the event in accordance with the event identifier, the temporal descriptor, and the one of the plurality of location labels.
